(19) United States
(12) Patent Application Publication
(10) Pub. No.: US 2015/0370696 A1
(43) Pub. Date: Dec. 24, 2015

(54) METHOD AND APPARATUS FOR DISPLAYING PC REAL BROWSING EFFECT FOR MOBILE PHONE INTERFACE

(71) Applicant: Beijing Jinher Software Co.,Ltd, Beijing (CN)

(72) Inventor: Runfeng LUAN, Beijing (CN)

(21) Appl. No.: 14/318,717

(22) Filed: Jun. 30, 2014

(30) Foreign Application Priority Data
Jun. 18, 2014 (CN) 201410273433.4

(51) Int. Cl. G06F 11/36; G06F 3/0481; G06F 9/44; G06F 3/0486

(52) U.S. Cl. CPC G06F 11/3696; G06F 3/0486; G06F 3/0481; G06F 8/38; G06F 11/3664

(57) ABSTRACT

The present invention relates to the field of displaying a mobile phone interface, and particularly to a method and apparatus for displaying a PC real browsing effect for a mobile phone interface, comprise: a step and device for displaying applications and master keys of a the main interface of the mobile phone on the PC user interface; a step and device for detecting a predefined user action made by a user on the PC user interface, wherein the predefined user action comprises a first predefined user action and a second predefined user action, a step and device for, upon detecting that the first predefined user action is associated with any one of the applications, displaying an application interface of the application or an application interface of a lower level on the PC user interface.

### CROSS-REFERENCE TO RELATED APPLICATIONS

This application claims the priority benefit of Chinese application No.201410273433.4, which was filed on Jun. 18, 2014. The entirety of the above-mentioned patent application is hereby incorporated by reference herein and made a part of specification.

### BACKGROUND OF THE INVENTION

### Field of the Invention

The present invention relates to the field of displaying a mobile phone interface, and particularly to a method and apparatus for displaying a PC real browsing effect for a mobile phone interface.

### Background of the Invention

Nowadays, in the field of development of mobile phone applications, when a new application has been developed, it is required to test various performances and using effects of the new application. Specifically, it is necessary to install the application on the mobile phone for performing relevant tests. In case any problem is found and the application needs to be modified, the application has to be uninstalled from the mobile phone for modifications. These procedures are repeated until the expected using effect of the application is realized. The repeated installing and uninstalling leads to a huge work load, and the developer can not timely test and experience the using effect of the newly developed application, thus affecting the working efficiency.

### BRIEF SUMMARY OF THE INVENTION

In view of the above technical problems, the present invention develops a method and apparatus for displaying a PC real browsing effect for a mobile phone interface. The aim of the present invention is to intuitively display the using effect of an application on the PC and offer a real user experience without installing the application on the mobile phone, thus decreasing the workload for debugging the application and improving the working efficiency.

The technical solutions of the present invention provide lie in the following aspects.

A method for displaying a PC real browsing effect for a mobile phone interface comprises:

displaying applications of a the main interface of the mobile phone and master keys of the mobile phone on a PC user interface;

detecting a predefined user action made by a user on the PC user interface, wherein the predefined user action comprises a first predefined user action and a second predefined user action;

upon detecting that the first predefined user action is associated with any one of the applications, in response to the first predefined user action, displaying an application interface of the application or an application interface of a lower level on the PC user interface; and

upon detecting that the second predefined user action is associated with any one of the master keys, in response to the second predefined user action, displaying an interface of the corresponding master key on the PC user interface.

Preferably, in the present method, the predefined user action further comprises a third predefined user action, wherein the third predefined user action is an action of dragging any point to another point on the application interface of the application or the application interface of the lower level.

Preferably, in the present method, the applications comprise a multiple-page displaying application and a seamless displaying application.

Preferably, in the present method, the third predefined user action acts on the seamless displaying application.

Preferably, in the present method, the seamless displaying application is provided with a fixed area on which the third predefined user action acts.

Preferably, in the present method, the master keys comprise a functional key, a home key, and a return key.

Preferably, the present method further comprises: upon detecting that the second predefined user action is associated with any one of the master keys, in response to the second predefined user action, displaying an interface of the functional key, an interface of the mobile phone main, or an application interface of a higher level application interface with respect to the current application on the PC user interface.

An apparatus for displaying a PC real browsing effect for a mobile phone interface comprises:

a device for displaying applications of a the main interface of the mobile phone and master keys of the mobile phone on a PC user interface;

a device for detecting a predefined user action made by a user on the PC user interface, wherein the predefined user action comprises a first predefined user action and a second predefined user action;

a device for, upon detecting that the first predefined user action is associated with any one of the applications, in response to the first predefined user action, displaying an application interface of the application or an application interface of a lower level on the PC user interface; and

a device for, upon detecting that the second predefined user action is associated with any one of the master keys, in response to the second predefined user action, displaying an interface of the corresponding master key on the PC user interface.

Preferably, in the present apparatus, the predefined user action further comprises a third predefined user action, wherein the third predefined user action is an action of dragging any point to another point on the application interface of the application or the application interface of the lower level.

Preferably, in the present apparatus, the applications comprise a multiple-page displaying application and a seamless displaying application.

Preferably, in the present apparatus, the third predefined user action acts on the seamless displaying application.

Preferably, in the present apparatus, the seamless displaying application is provided with a fixed area on which the third predefined user action acts.

Preferably, in the present apparatus, the master keys comprise a functional key, a home key, and a return key.

Preferably, in the present apparatus, further comprises a device for, upon detecting that the second predefined user action is associated with any one of the master keys, in response to the second predefined user action, displaying an interface of the functional key, an interface of the mobile phone main, or an application interface of a higher level application interface with respect to the current application on the PC user interface.

In the method and apparatus for displaying a PC real browsing effect for the mobile phone interface of the present invention, the application interface of the mobile phone application is directly displayed on the user PC, and the application can be operated on the PC in real time for browsing. In this way, it is possible to realize reality and operability the mobile phone application on the PC, improve the user experience, decrease the workload for debugging the application, and improve the working efficiency for the developer.

### DETAILED DESCRIPTION OF THE INVENTION

The present invention will be described in detail hereinafter by referring to its embodiments, so that the skilled in the art can implement the present invention in accordance with the present disclosure.

The present invention provides a method for displaying a PC real browsing effect for a mobile phone interface, comprising:

displaying applications of a the main interface of the mobile phone and master keys of the mobile phone on a PC user interface, wherein the main interface and master keys of the mobile phone are displayed on a central display area of the PC user interface in the same manner as they are displayed on a screen of the mobile phone, wherein the applications comprise common applications like Address book, Message, Internet, Clock, Setting, Camera, Calendar, Album, Calculator, Notepad, WeChat, QQ, or the like, and wherein the master keys comprise a functional key, a home key, and a return key and are displayed below the main interface of the mobile phone;

detecting a predefined user action made by a user on the PC user interface, i.e., an action that the user manipulates the mouse so that the mouse's pointer acts on the central display area of the PC user interface, wherein the predefined user action comprises a first predefined user action and a second predefined user action, both actions involve to click a left key of the mouse, with the exception in the operation object of these actions, and wherein the operation object of the first predefined user action is any one of the applications, while the operation object of the second predefined user action is any one of the master keys;

upon detecting that the first predefined user action is associated with any one of the applications, in response to the first predefined user action, displaying an application interface of the application or an application interface of a lower level on the PC user interface, namely, when the mouse's pointer points to any one of the applications on the main interface of the mobile phone, the left key of the mouse is clicked on this application, the application interface of this application is displayed on the central display area of the PC user interface; for example, when “Setting” is clicked on the main interface of the mobile phone, the application interface of “Setting” is displayed on the central display area of the PC user interface, and the application interface of “Setting” comprises wireless and network, international roaming setting, call setting, contextual model, USB connection setting, location and security, date and time, or the like; when “Album” is clicked on the main interface of the mobile phone, the application interface of “Album” is displayed on the central display area of the PC user interface, and the application interface comprises pictures from the camera, pictures from Bluetooth, pictures from files, or the like; if the application interface of a certain application, e.g., the application interface of “Setting”, is being displayed on the central display area of the current PC user interface, when the left key of the mouse is clicked, an application interface of any lower level of “Setting” to which the mouse points, e.g., an application interface of time and date, is displayed on the central display area of the PC user interface, wherein the application interface of time and date comprises date setting, time zone selection, time setting, time format setting, date format setting, or the like; if an application interface of “Album” is currently being displayed, when the left key of the mouse is clicked, an application interface of any lower level of “Album” to which the mouse points, e.g., an application picture of Bluetooth pictures, is displayed on the central display area of the PC user interface, namely, pictures received via Bluetooth are displayed on the central display area in the form of icons; and

upon detecting that the second predefined user action is associated with any one of the master keys, in response to the second predefined user action, displaying an interface of the corresponding master key on the PC user interface, namely, when the mouse's pointer points to any one of the functional key, the home key, and the return key of the mobile phone, the page of the selected master key is displayed on the PC user interface; for example, regardless of the interface which is being displayed on the central display area of PC, when the mouse's pointer points at the home key and the left key of the mouse is clicked, the central display area of the PC user interface always displays the main interface of the mobile phone; when the mouse's pointer points at the functional key, the functional interface corresponding to the application interface of the application is displayed below the interface being displayed currently.

In the present method, the predefined user action further comprises a third predefined user action, wherein the third predefined user action is an action of dragging any point to another point on the application interface of the application or the application interface of the lower level, i.e., an action in which the user clicks the left key of the mouse, keeps pressing the left key, and drags in the application interface of the application or the application interface of a lower level. For example, in case that the application interface of “Address Book” is being displayed on the central display area of the current PC user interface, when the user clicks the left key of the mouse and keeps pressing the left key, the contact information in the address book will be successively displayed on the central display area if the mouse is dragged from the bottom up, while the contact information in the forepart of the address book will be showed in the mouse is dragged from the top down. In case that the application interface of “Phoenix News” in “Internet” is being displayed on the central display area of the current PC user interface, when the user clicks the left key of the mouse, keeps pressing the left key, and drags the mouse from the bottom up, the user is presented with each news information.

In the present method, the applications comprise a multiple-page displaying application and a seamless displaying application. The multiple-page displaying applications are applications in which, under the action of clicking the mouse, the current display page of the application can only be replaced by the next display page, such as the Message, Clock, Setting, and Album, as well as the first level of Internet, WeChat, and QQ. The first level display interface for “Message” application comprises Inbox, Outbox, Draft box, or the like. When the user manipulates the mouse by clicking “Inbox”, the application interface of “Inbox” is displayed on the central display area of the PC user interface. The application interface of “Inbox” comprises messages sent from different contacts, and completely replaces the first level display of “Message”. The seamless displaying applications are applications in which, under the action of dragging the mouse, e.g., dragging from the top down, from the bottom up, from left to right, and from right to left, the application interface is displayed on the PC user interface in a continuous rolling mode, such as the address book, and calendar, as well as the non-first level interface of Internet, WeChat, QQ. For example, the first level interface of QQ comprises dialogue, contacts, QQ space, group/discussion group, or the like. When the user manipulates the mouse to access the “My Friends” interface in “Contacts” to check the friend list, it is required to drag the scrollbar at the right side of the “My Friends” interface, so that the friend list is displayed on the central display area.

In the present method, the third predefined user action acts on the seamless displaying application. Namely, the action of dragging can only be performed with respect to an application the application interface of which is displayed continuously. For example, when the user manipulates the mouse by clicking the application “Calendar”, the date of the current month like June, 2014 is displayed on the central display area of the PC user interface. The user is required to drag the current interface from the top down, from the bottom up, from left to right, or from right to left, so as to display the date prior to or following the current month. When the user manipulates the mouse by clicking “Circle of Friends” in the application “WeChat”, various messages which are posted by friends at a time closest to the current time are displayed on the central display area of the PC user interface. The user is required to manipulate the mouse to drag the current page from the bottom up, so as to browse older messages posted by friends.

In the present method, the seamless displaying application is provided with a fixed area on which the third predefined user action acts. For example, the fixed area is the scrollbar at the right side of the second level interface of “Internet”, or the scrollbar at the right side of “Tencent News” interface in “WeChat”.

In the present method, the master keys comprise a functional key, a home key, and a return key. The functional keys are arranged in a manner in which they correspond to each of the applications. For example, the functional keys of “Address Book” comprise searching, batch operation, import/export, delete, or the like. The functional keys of “Message” comprise searching, editing folder, sending messages to a group, setting, or the like. The functional keys of “Internet” comprise new window, bookmark, refreshing, or the like. The functional keys of “Calendar” comprise day, week, month, schedule, or the like.

The present method further comprises, upon detecting that the second predefined user action is associated with any one of the master keys, in response to the second predefined user action, displaying the current application an interface of the functional key, an interface of the mobile phone main, or an application interface of a higher level application interface with respect to the current application on the PC user interface. Namely, when the mouse's pointer points at any one of the master keys and the mouse is clicked, PC can always perform the corresponding operations and display the results. For example, in case that the application interface of “Camera” is displayed on the central display area of the current PC user interface, when the user manipulates the mouse to point the pointer at a functional key and clicks the mouse, two functional modules of “Switching to video shooting” and “Album” which are associated with “Camera” are displayed below the current interface. When the “Album” is clicked, the application interface of “Album” replaces the application interface of “Camera” to be displayed on the central display area of the PC user interface.

An apparatus for displaying a PC real browsing effect for a mobile phone interface comprises:

a device for displaying applications of a the main interface of the mobile phone and master keys of the mobile phone on a PC user interface;

a device for detecting a predefined user action made by a user on the PC user interface, wherein the predefined user action comprises a first predefined user action and a second predefined user action;

a device for, upon detecting that the first predefined user action is associated with any one of the applications, in response to the first predefined user action, displaying an application interface of the application or an application interface of a lower level on the PC user interface; and

a device for, upon detecting that the second predefined user action is associated with any one of the master keys, in response to the second predefined user action, displaying an interface of the corresponding master key on the PC user interface.

In the present apparatus, the predefined user action further comprises a third predefined user action, wherein the third predefined user action is an action of dragging any point to another point on the application interface of the application or the application interface of the lower level.

In the present apparatus, the applications comprise a multiple-page displaying application and a seamless displaying application.

In the present apparatus, the third predefined user action acts on the seamless displaying application.

In the present apparatus, the seamless displaying application is provided with a fixed area on which the third predefined user action acts.

In the present apparatus, the master keys comprise a functional key, a home key, and a return key.

The present apparatus further comprises a device for, upon detecting that the second predefined user action is associated with any one of the master keys, in response to the second predefined user action, displaying an interface of the functional key, an interface of the mobile phone main, or an application interface of a higher level application interface with respect to the current application on the PC user interface.

Although the present invention has been described above with reference to specific embodiments, it should be understood that the limitations of the described embodiments are merely for illustrative purpose and by no means limiting. Instead, the scope of the invention is defined by the appended claims rather than by the description, and all variations that fall within the range of the claims are intended to be embraced therein. Thus, other embodiments than the specific ones described above are equally possible within the scope of these appended claims.

1. A method for displaying a PC real browsing effect for a mobile phone interface, characterized by comprising:
displaying applications of a the main interface of the mobile phone and master keys of the mobile phone on a PC user interface;
detecting a predefined user action made by a user on the PC user interface, wherein the predefined user action comprises a first predefined user action and a second predefined user action;
upon detecting that the first predefined user action is associated with any one of the applications, in response to the first predefined user action, displaying an application interface of the application or an application interface of a lower level on the PC user interface; and
upon detecting that the second predefined user action is associated with any one of the master keys, in response to the second predefined user action, displaying an interface of the corresponding master key on the PC user interface.

2. The method of claim 1, characterized in that,
the predefined user action further comprises a third predefined user action, wherein the third predefined user action is an action of dragging any point to another point on the application interface of the application or the application interface of the lower level.

3. The method of claim 2, characterized in that,
the applications comprise a multiple-page displaying application and a seamless displaying application.

4. The method of claim 3, characterized in that,
the third predefined user action acts on the seamless displaying application.

5. The method of claim 4, characterized in that,
the seamless displaying application is provided with a fixed area on which the third predefined user action acts.

6. The method of claim 1, characterized in that,
the master keys comprise a functional key, a home key, and a return key.

7. The method of claim 6, characterized in that,
upon detecting that the second predefined user action is associated with any one of the master keys, in response to the second predefined user action, displaying an interface of the functional key, an interface of the mobile phone main, or an application interface of a higher level application interface with respect to the current application on the PC user interface.

8. An apparatus for displaying a PC real browsing effect for a mobile phone interface, characterized by comprising:
a device for displaying applications of a the main interface of the mobile phone and master keys of the mobile phone on a PC user interface;
a device for detecting a predefined user action made by a user on the PC user interface, wherein the predefined user action comprises a first predefined user action and a second predefined user action;
a device for, upon detecting that the first predefined user action is associated with any one of the applications, in response to the first predefined user action, displaying an application interface of the application or an application interface of a lower level on the PC user interface; and
a device for, upon detecting that the second predefined user action is associated with any one of the master keys, in response to the second predefined user action, displaying an interface of the corresponding master key on the PC user interface.

9. The apparatus of claim 8, characterized in that,
the predefined user action further comprises a third predefined user action, wherein the third predefined user action is an action of dragging any point to another point on the application interface of the application or the application interface of the lower level.

10. The apparatus of claim 9, characterized in that,
the applications comprise a multiple-page displaying application and a seamless displaying application.

11. The apparatus of claim 10, characterized in that,
the third predefined user action acts on the seamless displaying application.

12. The apparatus of claim 11, characterized in that,
the seamless displaying application is provided with a fixed area on which the third predefined user action acts.

13. The apparatus of claim 8, characterized in that,
the master keys comprise a functional key, a home key, and a return key.

14. The apparatus of claim 13, characterized by further comprising:
a device for, upon detecting that the second predefined user action is associated with any one of the master keys, in response to the second predefined user action, displaying an interface of the functional key, an interface of the mobile phone main, or an application interface of a higher level application interface with respect to the current application on the PC user interface.
